(19) United States
(12) Patent Application Publication
(10) Pub. No.: US 2017/0192253 A1
(43) Pub. Date: Jul. 6, 2017

(54) OPTICAL ELEMENTS FOR POWER ADJUSTABLE SPECTACLES

(71) Applicants: TECHNION RESEARCH & DEVELOPMENT FOUNDATION LTD., Haifa (IL); CONSEJO SUPERIOR DE INVESTIGACIONES CIENTIFICAS, Madrid (ES)

(72) Inventors: Jacob RUBINSTEIN, Haifa (IL); Sergio BARBERO BRIONES, Madrid (ES)

(21) Appl. No.: 15/308,625

(22) PCT Filed: May 21, 2015
(86) PCT No.: PCT/IL2015/050536

§ 371 Date: Nov. 3, 2016

Related U.S. Application Data
(60) Provisional application No. 62/001,301, filed on May 21, 2014.

(51) Int. Cl. G02C 7/08; G02C 7/02

(52) U.S. Cl. CPC G02C 7/081; G02C 7/028; G02C 2202/16

(57) ABSTRACT

An optical element for use in power adjustable spectacles comprises a front lens and a back lens which can slide laterally with respect to each other to achieve a first relative position and a second relative position. The optical element may be designed to provide good optical performance for far-distance viewing and for near-distance viewing, or to provide good optical performance for near-distance viewing and for intermediate-distance viewing. In some cases, the front lens and the back lens can slide laterally with respect to each other to achieve a third relative position, and the optical element may be designed to provide good optical performance for far-distance viewing, for intermediate-distance viewing and for near-distance viewing. In all cases, the predetermined addition of the prescription is in the range of 0.50 diopters to 3.00 diopters.

### TECHNICAL FIELD

The technology described herein relates generally to the design of optical elements for power adjustable spectacles, also known as adjustable eyeglasses or adjustable glasses, and also relates generally to the optical elements and the power adjustable spectacles.

### BACKGROUND

People start to lose their ability to focus at near-by objects around the age of 45. This medical condition is called presbyopia. It is caused by the reduced ability of the eye's lens to contract (accommodate). One solution is reading glasses (readers), which provide focus at near-by objects. They are used by people who do not require far-distance vision correction. Readers can also be used by people who do require far-distance vision correction, who in this case use two different pairs of glasses (one for far-distance, and readers for near-distance). Another solution is bi-focal spectacles. There, the lens is divided into two parts with a sharp discontinuity between the parts. The smaller part, located nearer to the nasal region, provides higher optical power than in the larger part, and therefore the smaller part has the focal point for near-distance vision. Another solution is multifocal lenses, also called Progressive Addition Lenses (PALs). Here the lens surface is smooth, and the optical power changes gradually as the eye moves downwards and in the nasal direction.

U.S. Pat. No. 3,305,294 to Alvarez, entitled “Two-element variable-power spherical lens”, discloses placing at each half of the spectacles frame a two-lens element with a special profile, such that laterally sliding one element with respect to the other element changes the optical power of the combined two-element lens. A particular example is when the two lens elements each have a planar surface, while the other surfaces are of the form

$$+ A \cdot ( \frac{1}{3} {x}^{3} + {xy}^{2} ) and - A \cdot ( \frac{1}{3} {x}^{3} + {xy}^{2} ) ,$$

respectively. Alvarez used the thin lens approximation to derive the lens equations set forth in that document (see col. 8, lines 3-16). A quick standard calculation, based on the thin lens approximation shows that a horizontal shift of δ implies an optical power change dS=4(n−1)Aδ in the forward gaze direction, where n is the refractive index of the lenses. Adjusting the parameter A and the shift δ can provide a prescribed power change to account for the lost accommodation of the person wearing the spectacles. The Alvarez profile (using surfaces of the form above) has poor overall optics. There were at least two difficulties with his design. First, Alvarez did not explicitly consider the effect of the two-element lens thickness on the power. This is problematic because the special profile he used yields a fast-growing thickness, and thus the thin lens approximation is not valid. Second, Alvarez neglected the fact that the eye scans a visual scene in many directions, and the optical performance is affected by this.

The Alvarez concept was revived in recent years with an entirely different purpose in mind: supplying affordable adjustable lenses to solve the functional blindness problem in developing countries. This problem affects a few hundred million people in the world. Some of these people do not have access to eyecare professionals, and thus do not even know their prescription. Supplying these people with correct spectacles is also difficult. Therefore, the option of power adjustable spectacles that can be adjusted by the wearer to optimally fix his/her eyesight seems promising.

The Alvarez concept as originally disclosed has been applied, together with a new design of frames that enable the lens relative shift, in U.S. Pat. No. 7,980,690 to Baron van Asbeck and in U.S. Pat. No. 7,637,608 to Van Der Heijde et al. Also of interest are the designs disclosed in PCT Publication No. WO2013/030603, PCT Publication No. WO2012/076840, and U.S. Publication No. 2013/0141692.

The inventors named in this instant application used the progress in understanding and designing spectacle lenses over the past 25 years to improve the optical quality of each optical element (combined from two lenses). This is disclosed in S. Barbero and J. Rubinstein, “Adjustable-focus lenses based on the Alvarez-Lohmann principle”, J. Optics, Vol. 13, 125705, published 2011. Indeed, an acceptable optical performance was achieved over a small optical window, and over a dynamic range of 5 diopters, which is a good range for the purpose of mass distribution of power adjustable spectacles in developing countries.

An alternative frame design was proposed in A. Zapata and S. Barbero, “Mechanical design of a power-adjustable spectacle lens frame”, J. Biomed. Opt., vol. 16, 055001-6, published 2011.

The requirement of a large dynamic range (at least 5 diopters) for the functional blindness problem in developing countries makes it very hard to provide good optical quality over a reasonable-sized optical window surrounding the forward gaze direction.

### SUMMARY

An optical element for use in power adjustable spectacles comprises a front lens and a back lens which can slide laterally with respect to each other to achieve a first relative position and a second relative position.

In a first case, the optical element may be designed to provide good optical performance for far-distance viewing and for near-distance viewing, where the prescription is of far-distance correction given by a predetermined optical power S with zero predetermined cylinder C and a predetermined addition A.

In a second case, the optical element may be designed to provide good optical performance for far-distance viewing and for near-distance viewing, where the prescription is of far-distance correction given by a predetermined optical power S with non-zero predetermined cylinder C in a cylinder direction α and a predetermined addition A.

In a third case, the optical element may be designed to provide good optical performance for intermediate-distance viewing and for near-distance viewing, where the prescription is of zero far-distance power correction (emmetropic) and zero cylinder and a predetermined addition A.

The front lens and the back lens may be able to slide laterally with respect to each other to achieve a third relative position, and the optical element may be designed to provide good optical performance for far-distance viewing, for intermediate-distance viewing and for near-distance viewing.

The predetermined addition A of the prescription is in the range of 0.50 diopters to 3.00 diopters.

Methods for designing the optical element are described.

### BRIEF DESCRIPTION OF DRAWINGS

FIG. 1 is a perspective view of power adjustable spectacles;

FIG. 2a and FIG. 2b are perspective views of an example optical element for use in power adjustable spectacles, the optical element consisting of a front lens and a back lens;

FIG. 3 is a cross-sectional view of an example optical element, illustrating a relative position of the front lens and the back lens when their planar surfaces are coincident (a “rest position”);

FIG. 4a and FIG. 4b are cross-sectional views of an example optical element, illustrating two different example relative positions of the lenses that may be achieved by sliding the front lens laterally while the back lens remains fixed;

FIG. 5a and FIG. 5b are cross-sectional views of an example optical element, illustrating two different example relative positions of the lenses that may be achieved by sliding the back lens laterally while the front lens remains fixed;

FIG. 6a and FIG. 6b are cross-sectional views of an example optical element, illustrating two different example relative positions of the lenses that may be achieved by sliding both the front lens and the back lens laterally in opposite directions relative to a frame of the power adjustable spectacles;

FIG. 7a and FIG. 7b are cross-sectional views of an example optical element that in the rest position provides an optical power of −3.00 diopters and in another configuration provides an optical power of −1.00 diopters;

FIG. 8a and FIG. 8b are cross-sectional views of an example optical element that in a first configuration shifted from the rest position provides an optical power of −3.00 diopters and in a second configuration shifted from the rest position provides an optical power of −1.00 diopters;

FIG. 9 is a simplified flowchart illustration of an example design method for designing an optical element to provide good optical performance for far-distance viewing and for near-distance viewing;

FIG. 10a and FIG. 10b illustrate multiple gaze directions for far-distance objects and for near-distance objects, respectively;

FIG. 11 is a simplified flowchart illustration of an example design method for designing an optical element to provide good optical performance for intermediate-distance viewing and for near-distance viewing;

FIG. 12 is a simplified flowchart illustration of an example design method for designing an optical element to provide good optical performance for far-distance viewing, for intermediate-distance viewing and for near-distance viewing;

FIG. 13a and FIG. 13b show the power error distribution and the cylinder error distribution, respectively, of an example optical element for different gaze directions while the lenses are in a first relative position, and FIG. 13c and FIG. 13d show the power error distribution and the cylinder error distribution, respectively, of the example optical element for different gaze directions while the lenses are in a second relative position, for an addition of +2.00 diopters;

FIG. 14a and FIG. 14b show the power error distribution and the cylinder error distribution, respectively, of an example optical element for different gaze directions while the lenses are in a first relative position, and FIG. 14c and FIG. 14d show the power error distribution and the cylinder error distribution, respectively, of the example optical element for different gaze directions while the lenses are in a second relative position, for an addition of +3.00 diopters; and

FIG. 15a and FIG. 15b show the power error distribution and the cylinder error distribution, respectively, of an example optical element for different gaze directions while the lenses are in a first relative position, and FIG. 15c and FIG. 15d show the power error distribution and the cylinder error distribution, respectively, of the example optical element for different gaze directions while the lenses are in a second relative position, for an addition of +1.00 diopters.

### DETAILED DESCRIPTION

Reference axes x-y-z are illustrated in the drawings and discussed throughout this document. When a person wears power adjustable spectacles containing an optical element, the z-axis is parallel to the forward gaze direction, the x-axis is parallel to a horizontal line joining the irises of the person's eyes, and they-axis is perpendicular to both the x-axis and the z-axis. As described below, a first lens has a planar surface and a second lens has a planar surface and the optical element consists of the two lenses positioned with their planar surfaces substantially in contact with each other. The x-y plane is parallel to the planar surface of the first lens and to the planar surface of the second lens. Lateral shifts along the x-axis are referred to as “horizontal” shifts, and lateral shifts along the y-axis are referred to as “vertical” shifts. In this document the term “planar surface” includes a surface that is substantially planar, for example, a spherical surface, or other surfaces, having a large radius of curvature.

The eye can hardly notice a difference of optical power or cylinder of under 0.25 diopters. This was established, for example, in G. J. Burton and N. D. Haig, “Effects of the Seidel aberrations on visual target discrimination”, Journal of the Optical Society of America, vol. 1, 373-385, published in 1985. See also R. Legras, N. Chateau, and W. N. Charman, “Assessment of just-noticeable differences for refractive errors and spherical aberration using visual simulation”, Optom. Vis. Sci. 81(9), 718-728, published in 2004. Therefore, this tolerance will be used throughout the description. The importance of precise cylinder may be less crucial in near-distance vision tasks due to the depth of focus increase during accommodation. That is, a typical human may find it tolerable for the cylinder to deviate from a prescribed cylinder (which may be zero diopters) by up to 0.5 diopters for near-distance vision tasks. Therefore this tolerance for cylinder error for near-distance viewing will be used throughout the description. Throughout the description and the claims, the phrase “does not deviate noticeably from . . . ” means “does not deviate from . . . more than the tolerance described hereinabove”, and the phrase “the deviation is tolerable” means “the deviation does not exceed the tolerance described hereinabove”.

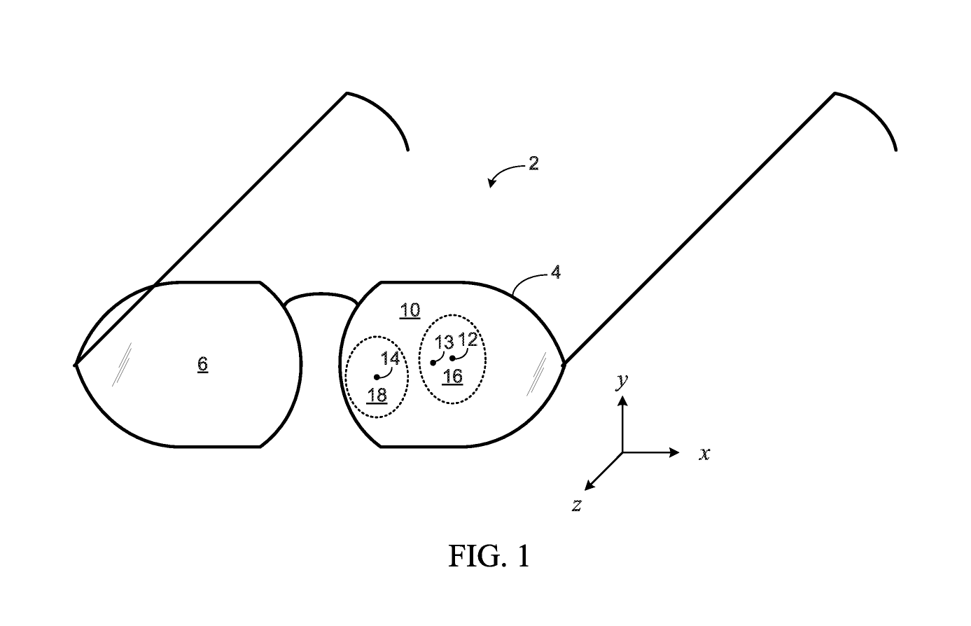

FIG. 1 is a perspective view of example power adjustable spectacles 2 (also known as adjustable eyeglasses or adjustable glasses). A frame 4 of the power adjustable spectacles 2 holds an optical element 6 for the right eye and an optical element 10 for the left eye. The following discussion describes properties of the optical element 10 and techniques for designing the optical element 10. The same techniques can be used to design the optical element 6 to have properties similar to the properties of the optical element 10.

The optical element 10 consists of two lenses (a front lens and a back lens) which can slide laterally (that is, in the x-y plane) with respect to each other to achieve a first relative position and a second relative position. The frame 4 provides the means by which the two lenses can slide laterally with respect to each other. Examples of such frames include the frames disclosed in U.S. Pat. No. 7,980,690 to Baron van Asbeck and in U.S. Pat. No. 7,637,608 to Van Der Heijde et al. and the frames disclosed in A. Zapata and S. Barbero, “Mechanical design of a power-adjustable spectacle lens frame”, J. Biomed. Opt., vol. 16, 055001-6, published 2011. Other frame designs that permit the two lenses to slide laterally with respect to each other to achieve a first relative position and a second relative position are also suitable.

In a first case, the optical element 10 is designed to provide good optical performance for far-distance viewing and for near-distance viewing to a person who has a left-eye prescription of far-distance power correction given by a predetermined optical power S with zero predetermined cylinder C and a predetermined addition A. The predetermined addition A is in the range of +0.50 diopters to +3.00 diopters. In the first case, a first point 12 that is substantially aligned with a forward gaze direction (parallel to the z-axis) and a second point 14 that is located near a nasal region of a person wearing the power adjustable spectacles 2 are identified. The forward gaze direction is suitable for viewing objects located a far distance (for example, 10 meters) from the eye. The second point 14 is located near the nasal region because when the eye views a near-by object (for example, an object located approximately 40 to 50 centimeters from the eye), the eye converges, that is, the eye moves downward and also towards the nasal region. The second point 14 is illustrated as shifted horizontally towards the nasal region and shifted vertically downwards relative to the first point 12. However, it is possible to locate the second point 14 at the same vertical height as the first point 12, and then the person wearing the power adjustable spectacles can slightly lower the power adjustable spectacles 2 to achieve the needed extra shift in the vertical direction.

To provide good optical performance in the first case, the optical element 10 is designed so that while the lenses are in the first relative position, the actual optical power within a first optical window 16 of acceptable size surrounding the first point 12 does not deviate noticeably from the predetermined optical power S (for example, does not deviate from S by more than 0.25 diopters) and the magnitude of the actual cylinder within the first optical window 16 does not deviate noticeably from zero cylinder (for example, does not deviate from zero by more than 0.25 diopters), and so that while the lenses are in the second relative position, the actual optical power within a second optical window 18 of acceptable size surrounding the second point 14 does not deviate noticeably from the sum of the predetermined optical power S and the predetermined addition A (for example, does not deviate from (S+A) by more than 0.25 diopters) and the magnitude of the actual cylinder within the second optical window 18 does not deviate noticeably from zero cylinder (for example, does not deviate from zero by more than 0.50 diopters).

In a second case, the optical element 10 is designed to provide good optical performance for far-distance viewing and for near-distance viewing to a person who has a left-eye prescription of far-distance power correction given by a first predetermined optical power (mean sphere) S with non-zero predetermined cylinder C in a cylinder direction α and a predetermined addition A. The predetermined addition A is in the range of +0.50 diopters to +3.00 diopters. In the second case, the first point 12 and the second point 14 are identified in exactly the same way as for the first case. Since imaging properties of spectacles are routinely measured in units of diopters, and since angles are measured in degrees (or radians), it is preferred to stick to a uniform unit (diopter) by using the notion of cross cylinders to take into account both the non-zero cylinder magnitude C and the cylinder direction α. Thus, a convenient way of expressing the prescription is to associate it with the dioptric matrix

$${T}_{P} = ( \begin{matrix}- S + {C}_{+} \\ {C}_{X}\end{matrix} \begin{matrix}{C}_{X} \\ - S + {C}_{+}\end{matrix} ) \qquad ( 1 )$$

where the cross cylinders C₊ and C_{X} are defined as

$${C}_{X} = \frac{c}{2} cos 2 α , {C}_{X} = \frac{c}{2} sin 2 α \qquad ( 2 )$$

The matrix T_{P} and its properties are well-known in the art, and are described, for example, in C. Campbell, “The dioptric group”, Optometry and Vision Science vol. 34, 382-387, published in 1997.

The concept of dioptric matrix can be used to express the difference between the prescription and the actual performance of the optical element. Suppose the actual power, cylinder and cylinder angle of the optical element at a given gaze direction are S₁, C₁ and α₁. The associated dioptric matrix is then

$${T}_{1} = ( \begin{matrix}- {S}_{1} + {C}_{1 , +} \\ {C}_{1 , X}\end{matrix} \begin{matrix}{C}_{1 , X} \\ - {S}_{1} + {C}_{1 , +}\end{matrix} ) \qquad ( 3 )$$

where the cross cylinders C_{1,+} and C_{1,X} are defined as

$${C}_{1 , +} = \frac{{c}_{1}}{2} {cos 2 α}_{1} , {C}_{X} = \frac{{c}_{1}}{2} sin 2 {α}_{1} \qquad ( 4 )$$

The absolute value of the deviation in optical power between the prescription and the actual performance of the optical element is defined as Sₑ=|S−S₁|. Similarly the deviation in the cross cylinders are defined as C_{e,+}=C₊−C_{1,+} and C_{e,X}=C_{1,X}−C_{X}. The total deviation of the cylinder between the prescription and the actual performance of the optical element in the given gaze direction is then defined by Cₑ=2\sqrt{C_{e,+}²+C_{e,X}²}.

To provide good optical performance in the second case, the optical element 10 is designed so that while the lenses are in the first relative position, the actual optical power S₁ within a first optical window 16 of acceptable size surrounding the first point 12 does not deviate noticeably from the predetermined optical power S (for example, the deviation Sₑ is no more than 0.25 diopters) and the actual cylinder C₁ and actual cylinder direction α₁ within the first optical window 16 do not deviate noticeably from the predetermined cylinder C in the cylinder direction α (for example, the deviation Cₑ is no more than 0.25 diopters), and so that while the lenses are in the second relative position, the actual optical power S₂ within a second optical window 18 of acceptable size surrounding the second point 14 does not deviate noticeably from the sum of the predetermined optical power S and the predetermined addition A (for example, S₂ does not deviate from (S+A) by more than 0.25 diopters) and the actual cylinder C₂ and actual cylinder direction α₂ within the second optical window 18 do not deviate noticeably from the predetermined cylinder C in the cylinder direction α (for example, the deviation Cₑ is no more than 0.50 diopters).

In a third case, the optical element 10 is designed to provide good optical performance for intermediate-distance viewing and for near-distance viewing to a person who has a left-eye prescription of zero far-distance power correction (emmetropic) and zero cylinder and a predetermined addition A. The predetermined addition A is in the range of +0.50 diopters to +3.00 diopters. A person who requires an addition A to view near-distance objects likely requires an optical power of (A−D) to view intermediate-distance objects (where the difference D is in the range of 0.50 diopters to 1.75 diopters, for example, 1.00 diopters) because some accommodation is needed, although not as much accommodation as for viewing near-distance objects. In other words, the power adjustable spectacles 2 using the optical element 10 are worn by the person as reading glasses (also known as “readers”) with the additional benefit of providing good optical performance for intermediate-distance viewing, such as computer tasks. In the third case, a third point 13 is substantially aligned not with the forward gaze direction but with a gaze direction that reflects the natural convergence of the eye when viewing objects located at an intermediate distance from the eye (for example, objects located approximately 70 to 100 centimeters from the eye). The second point 14 is identified in exactly the same way as for the first case and for the second case.

To provide good optical performance in the third case, the optical element 10 is designed so that while the lenses are in the first relative position, the actual optical power S₃ within a third optical window (not shown) of acceptable size surrounding the third point 13 does not deviate noticeably from (A−D) (for example, S₃ does not deviate from (A−D) by more than 0.25 diopters) and the magnitude of the actual cylinder C₃ within the third optical window does not deviate noticeably from zero cylinder (for example, does not deviate from zero by more than 0.25 diopters), and so that while the lenses are in the second relative position, the actual optical power S₂ within a second optical window 18 of acceptable size surrounding the second point 14 does not deviate noticeably from the predetermined addition (for example, S₂ does not deviate from A by more than 0.25 diopters) and the magnitude of the actual cylinder C₂ within the second optical window 18 does not deviate noticeably from zero cylinder (for example, does not deviate from zero by more than 0.50 diopters).

It is convenient to define the optical window as an ellipse with axes along the horizontal x and vertical y directions, respectively. In some cases, the major axis is along the horizontal x direction and the minor axis is along the vertical y direction. In other cases, the minor axis is along the horizontal x direction and the major axis is along the vertical y direction. An acceptable size of the first optical window 16 is an ellipse having an axis of approximately 30 degrees to 40 degrees (or larger) of eye rotation (measured as angular distance in the x-direction from a reference point surrounding the eye) and having an axis of approximately 30 degrees to 40 degrees (or larger) of eye rotation (measured as angular distance in the y-direction from the reference point surrounding the eye). An acceptable size of the second optical window 18 is an ellipse having an axis of approximately 30 degrees to 40 degrees (or larger) of eye rotation (measured as angular distance in the x-direction from a reference point surrounding the eye) and having an axis of approximately 30 degrees to 40 degrees (or larger) of eye rotation (measured as angular distance in the y-direction from the reference point surrounding the eye). In the first case and the second case, if the addition A does not exceed 1.0 diopters, it may be possible to achieve optical windows 16,18 that are ellipses having major and minor axes of approximately 45 degrees (or larger) by 45 degrees (or larger) of eye rotation (measured as angular distance in the x-direction and in the y-direction from a reference point surrounding the eye). In the third case, if the difference D does not exceed 1.0 diopters, it may be possible to achieve optical windows that are ellipses having major and minor axes of approximately 50 degrees (or larger) by 50 degrees (or larger) of eye rotation (measured as angular distance in the x-direction and in the y-direction from a reference point surrounding the eye).

The lenses of the optical element 10 may be able to slide laterally with respect to each other to achieve a third relative position between the first relative position and the second relative position. In the event that the optical element 10 is designed to provide good optical performance for far-distance viewing while the lenses are in the first relative position and to provide good optical performance for near-distance viewing while the lenses are in the second relative position, it is expected that the optical element 10 will provide good optical performance for intermediate-distance viewing while the lenses are in the third relative position. A person who has a left-eye prescription of far-distance power correction given by a predetermined optical power S (no cylinder) and a predetermined addition A (where A is in the range of +0.50 diopters to +3.00 diopters) likely requires an optical power of (S+A−D) to view intermediate-distance objects (where the difference D is in the range of 0.50 diopters to 1.75 diopters, for example, 1.00 diopters) because some accommodation is needed, although not as much accommodation as for viewing near-distance objects. In a variant of the first case, the optical element 10 may be designed so that while the lenses are in the third relative position, the actual optical power S₃ within the third optical window (not shown) of acceptable size surrounding the third point 13 does not deviate noticeably from (S+A−D) (for example, S₃ does not deviate from (S+A−D) by more than 0.25 diopters) and the magnitude of the actual cylinder C₃ within the third optical window does not deviate noticeably from zero cylinder (for example, does not deviate from zero by more than 0.25 diopters). In a variant of the second case, the optical element 10 may be designed so that while the lenses are in the third relative position, the actual optical power S₃ within the third optical window (not shown) of acceptable size surrounding the third point 13 does not deviate noticeably from (S+A−D) (for example, S₃ does not deviate from (S+A−D) by more than 0.25 diopters) and the actual cylinder C₃ and actual cylinder direction α₃ within the third optical window do not deviate noticeably from the predetermined cylinder C in the cylinder direction α (for example, the deviation Cₑ is no more than 0.25 diopters).

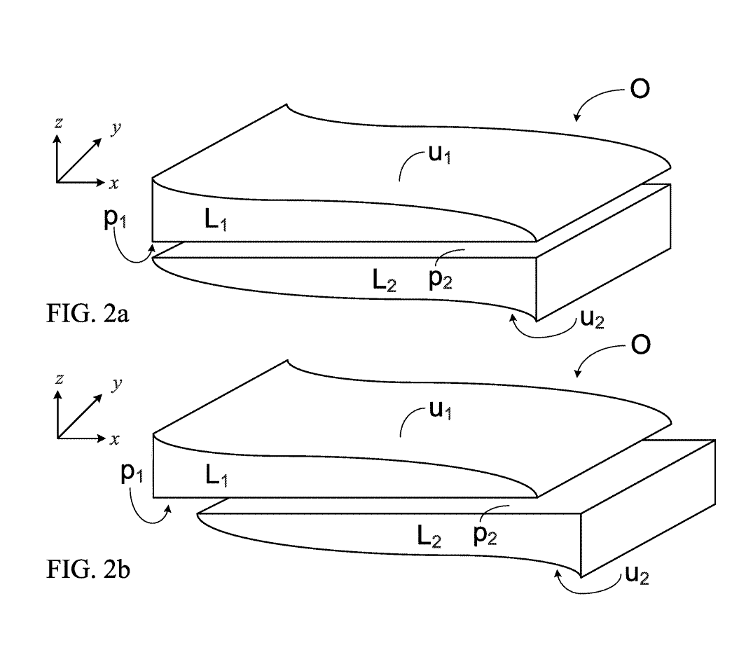

FIG. 2a and FIG. 2b are perspective views of an example optical element O for use in power adjustable spectacles. The optical element O is an example of the optical element 10. A front lens L₁ has a first planar surface p₁ and a front designed surface u₁. A back lens L₂ has a second planar surface p₂ and a back designed surface u₂. The optical element O consists of the front lens L₁ and the back lens L₂, positioned with their respective planar surfaces p₁ and p₂ substantially in contact with each other (illustrated as slightly apart in the z-direction, for clarity). The front lens L₁ and the back lens L₂ can slide laterally with respect to each other. FIG. 2a illustrates the optical element O while the lenses are in a first example relative position, and FIG. 2b illustrates the optical element O while the lenses are in a second example relative position.

When the optical element O is used in power adjustable spectacles (not shown), the front lens L₁ is farther from an eye of the person wearing the power adjustable spectacles and the back lens L₂ is nearer to the eye.

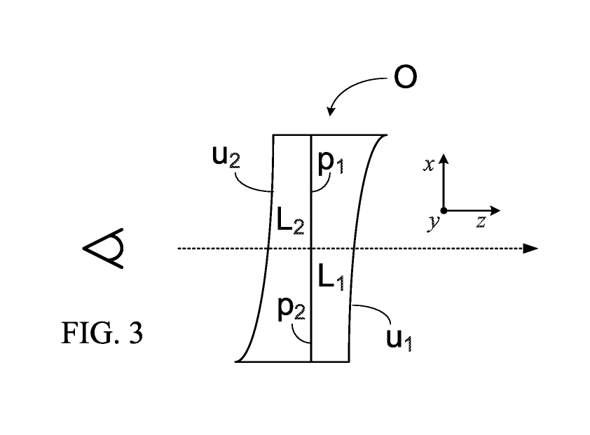

One of the relative positions of the lenses may be achieved when the planar surfaces p₁ and p₂ of the front lens L₁ and the back lens L₂, respectively, are coincident. In other words, the planar surfaces p₁ and p₂ are substantially in contact with each other and are not laterally shifted one with respect to the other. This relative position is referred to as a “rest position”. This is illustrated as a cross-sectional view in FIG. 3.

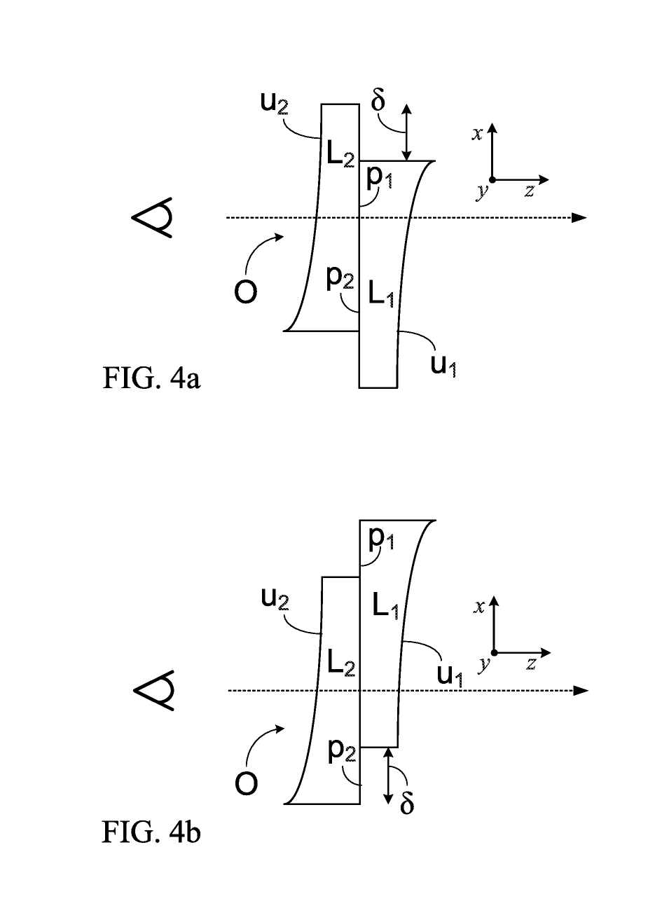

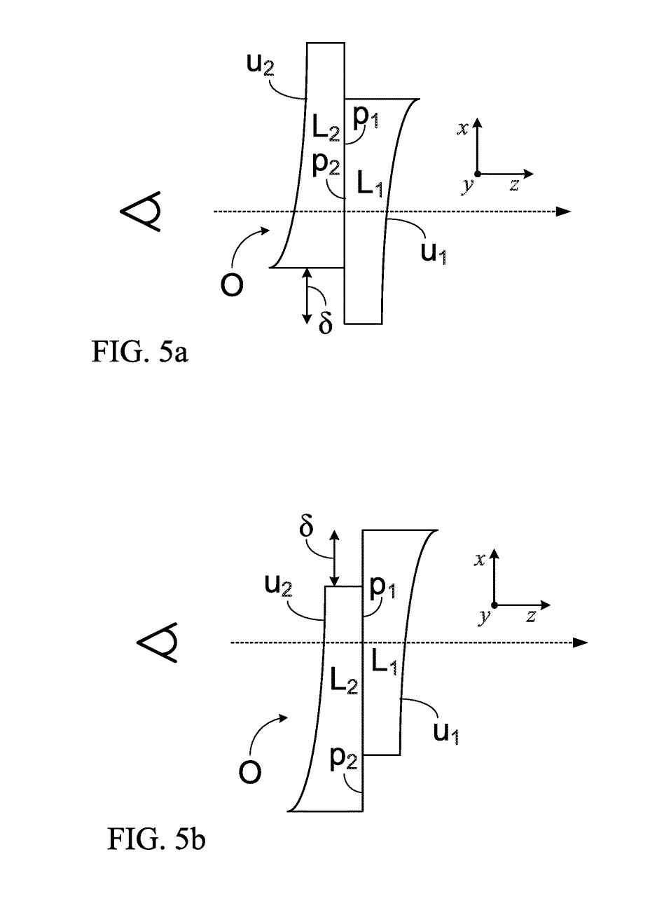

One or more of the relative positions of the lenses may be achieved by sliding one of the lenses laterally relative to a frame of the power adjustable spectacles while the other lens remains fixed relative to the frame. FIG. 4a and FIG. 4b are cross-sectional views of the optical element O, illustrating two different example relative positions of the lenses that may be achieved by sliding the front lens L₁ laterally relative to a frame of the power adjustable spectacles, while the back lens L₂ remains fixed relative to the frame. FIG. 5a and FIG. 5b are cross-sectional views of the optical element O, illustrating two different example relative positions of the lenses that may be achieved by sliding the back lens L₂ laterally relative to a frame of the power adjustable spectacles, while the front lens L₁ remains fixed relative to the frame.

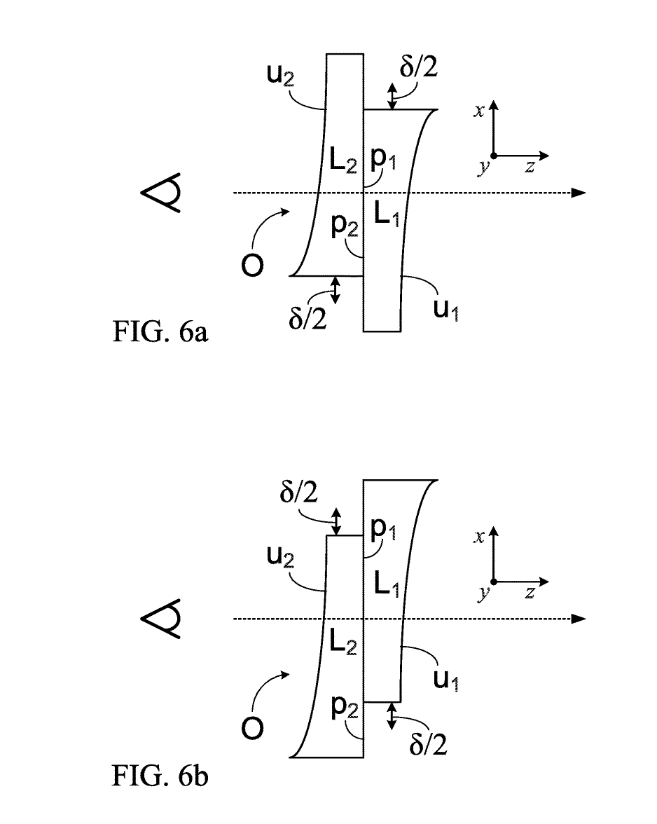

One or more of the relative positions of the lenses may be achieved by sliding both the first lens and the back lens laterally in opposite directions relative to a frame of the power adjustable spectacles. “Opposite directions” includes directions having vertical components in the same direction and having opposite horizontal components. FIG. 6a and FIG. 6b are cross-sectional views of the optical element O, illustrating two different example relative positions of the lenses that may be achieved by sliding both the front lens L₁ and the back lens L₂ laterally in opposite directions relative to a frame of the power adjustable spectacles.

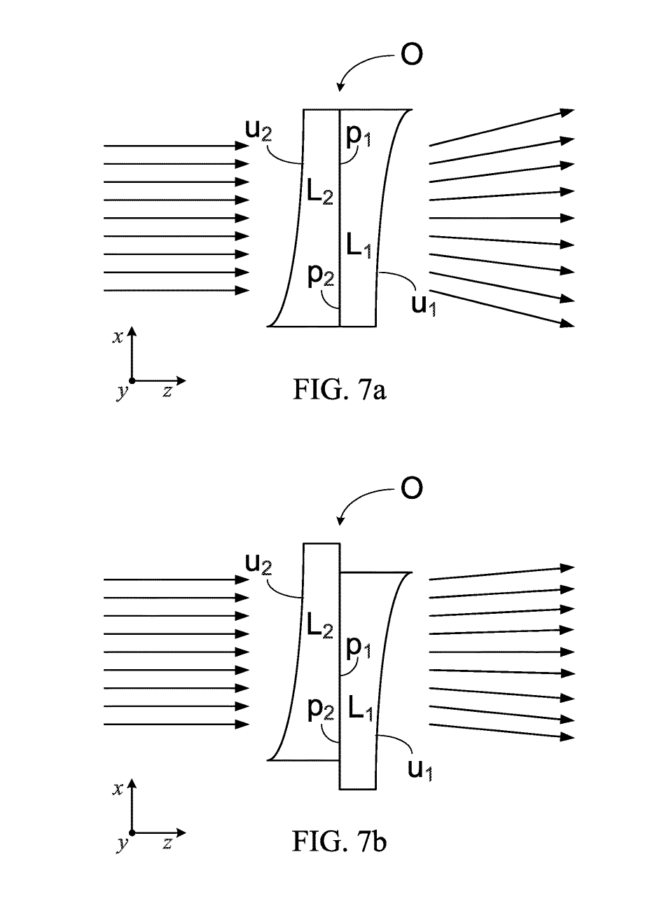

For example, the optical element O may be designed to provide an optical power of −3.00 diopters while the planar surfaces of the lenses are coincident (illustrated in FIG. 7a) and to provide an optical power of −1.00 diopters while the lenses are in a second relative position achieved by shifting the front lens while keeping the back lens fixed (illustrated in FIG. 7b).

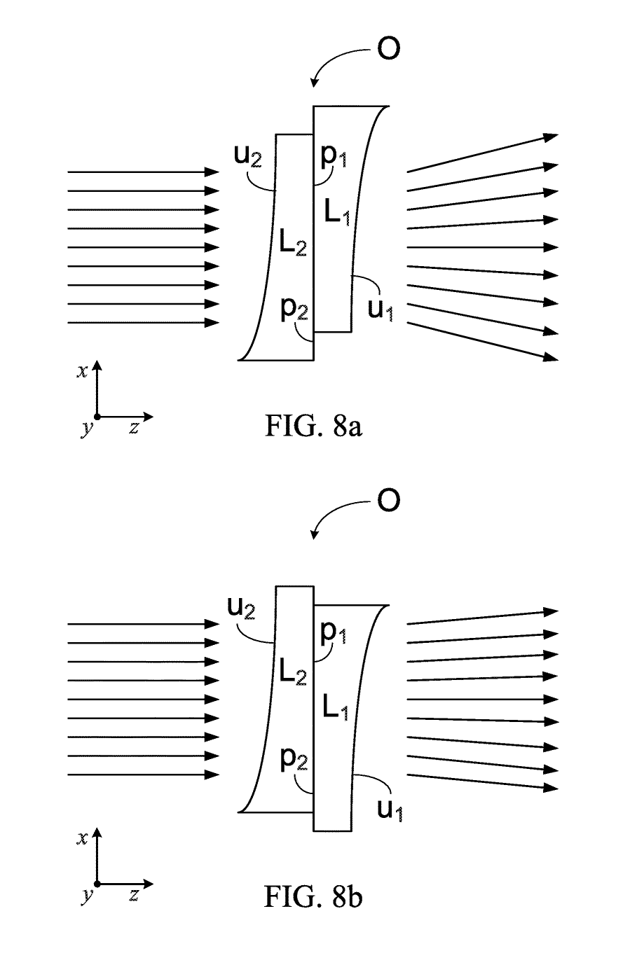

In another example, the optical element O may be designed to provide an optical power of −3.00 diopters while the lenses are in a first relative position achieved by shifting the front lens in the positive horizontal direction (illustrated in FIG. 8a) and to provide an optical power of −1.00 diopters while the lenses are in a second relative position achieved by shifting the front lens in the negative horizontal direction (illustrated in FIG. 8b). Note that in the rest position (not shown), this optical element provides an optical power between −3.00 diopters and −1.00 diopters.

Design Method: Far-Distance and Near-Distance

In the first case and in the second case described above, the object of the design method is to design an optical element O that in a first configuration provides good optical performance suitable for far-distance vision and in a second configuration provides good optical performance suitable for near-distance vision. The good optical performance suitable for far-distance vision is expected to occur around a first point that is substantially aligned with a forward gaze direction, and the good optical performance suitable for near-distance vision is expected to occur around a second point that is substantially aligned with a gaze direction that reflects the natural convergence of the eye when viewing a near-by object. Thus the second point is nearer to a nasal region of a person wearing adjustable glasses using the optical element O.

The optical element O to be designed consists of a front lens L₁ and a back lens L₂ which can slide laterally with respect to each other to achieve a first relative position and a second relative position. When the lenses are in the first relative position, the optical element O is said to be in the first configuration. When the lenses are in the second relative position, the optical element O is said to be in the second configuration. In some cases, the front lens L₁ and the back lens L₂ can slide laterally with respect to each other to achieve a third relative position between the first relative position and the second relative position. When the lenses are in the third relative position, the optical element O is said to be in the third configuration.

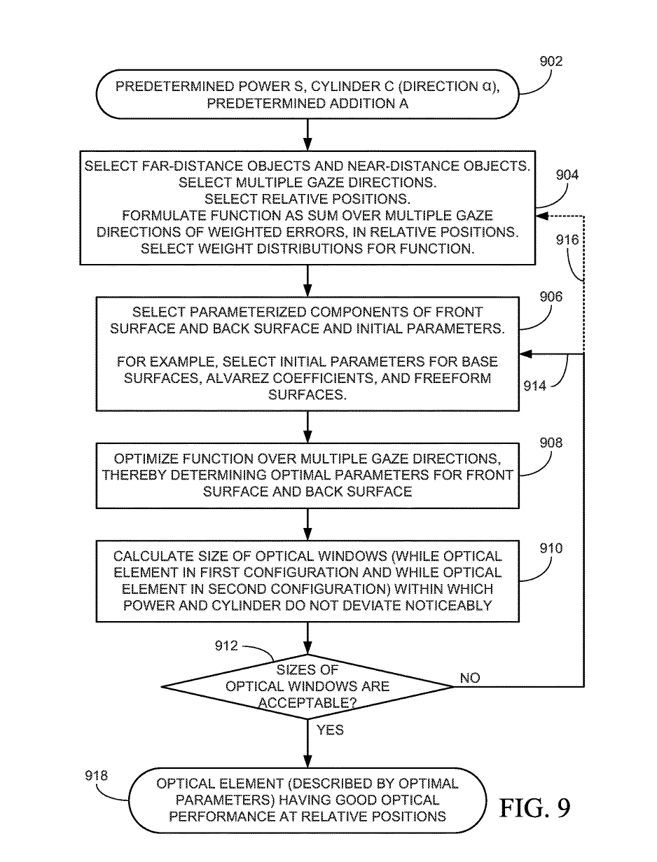

FIG. 9 is a simplified flowchart illustration of an example design method for designing the optical element O to provide good optical performance for far-distance viewing and for near-distance viewing, as in the first case described above or as in the second case described above. At 902, the design method receives as input a predetermined optical power S, a predetermined addition A, a predetermined cylinder C (which may be zero or non-zero), and, in the case that the predetermined cylinder C is non-zero, a predetermined cylinder direction α. The predetermined addition A is in the range of +0.50 diopters to +3.00 diopters, and is likely one of the following {+0.50 diopters, +1.00 diopters, +1.50 diopters, +2.00 diopters, +2.50 diopters, +3.00 diopters} or one of the following {+0.50 diopters, +0.75 diopters, +1.00 diopters, +1.25 diopters, +1.50 diopters, +1.75 diopters, +2.00 diopters, +2.25 diopters, +2.50 diopters, +2.75 diopters, +3.00 diopters}.

The design method involves the optimization of a function E, where the function E is a sum over multiple gaze directions of weighted terms involving the optical power and the cylinder, while the optical element O is in the first configuration (that is, the lenses are in the first relative position) and while the optical element O is in the second configuration (that is, the lenses are in the second relative position).

At 904, a framework for the design method is created. A coordinate system is defined, for example, an x-y-z coordinate system surrounding the eye. Far-distance objects (to be viewed when the optical element O is in the first configuration) and near-distance objects (to be viewed when the optical element O is in the second configuration) are selected. The far-distance objects may be located approximately 10 meters from the eye. The near-distance objects may be located approximately 40 to 50 centimeters from the eye. Multiple gaze directions are selected. These gaze directions can be expressed angularly along the x- and y-directions, with a forward gaze direction having projection angles of zero degrees in both the x- and y-directions. The relative positions of the lenses that define the first configuration and the second configuration are selected. The function E is formulated, and weight distributions are selected. Examples of the function E are described below.

The front lens L₁ has a front surface u₁ to be designed by this method and the back lens L₂ has a back surface u₂ to be designed by this method. (The other surfaces of the front lens L₁ and the back lens L₂ may be considered to be planar surfaces p₁ and p₂ that are substantially in contact with each other.)

At 906, parameterized components for the front surface u₁ and for the back surface u₂, and initial parameters for the components are selected. For example, the front surface u₁ of the front lens L₁ may be formulated as:

$${u}_{1} ( x , y ) = {u}_{b , 1} ( x , y ) + {A}_{1} \cdot ( \frac{1}{3} {x}^{3} + {xy}^{2} ) + {F}_{1} ( x , y ) , \qquad ( 5 )$$

and the back surface u₂ of the back lens L₂ may be formulated as:

$${u}_{2} ( x , y ) = {u}_{b , 2} ( x , y ) + {A}_{2} \cdot ( \frac{1}{3} {x}^{3} + {xy}^{2} ) + {F}_{2} ( x , y ) , \qquad ( 6 )$$

where the front surface u₁ and back surface u₂ each have a base surface component, an Alvarez surface component, and a free-form surface component.

The base surfaces u_{b,1} and u_{b,2} provide the optical power of the optical element O when in the rest position, in the absence of the other terms in equations (5) and (6), which may be the predetermined optical power S. They may be standard aspherical surfaces known in the art, or similar surfaces designed specifically for the present optical element by methods known in the art. For example, each base surface can take the form

$$\begin{matrix}{u}_{b , 1} = \frac{{c}_{1} {r}^{2}}{1 + \sqrt{1 - ( {K}_{1} + 1 ) {c}_{1} {r}^{2}}} , & ( 7 ) \\ {u}_{b , 2} = \frac{{c}_{2} {r}^{2}}{1 + \sqrt{1 - ( {K}_{2} + 1 ) {c}_{2} {r}^{2}}} , & ( 8 )\end{matrix}$$

where, in this example, the parameters of these components are the radius of curvature c₁ and c₂, and the asphericity K₁ and K₂, and r=\sqrt{x²+y²}.

As noted in more detail below, in cases where the predetermined cylinder C is non-zero, convergence of the optimization may be enhanced by selecting base surfaces u_{b} and u_{b,2} that provide not only the predetermined optical power S but also the predetermined cylinder C at the predetermined cylinder direction α. Such base surfaces, which are toric surfaces, are known in the art.

The

$$( \frac{1}{3} {x}^{3} + {xy}^{2} )$$

cubic terms are the base Alvarez surfaces known in the art, and, in this example, the Alvarez coefficients A₁ and A₂ are the parameters of these components.

Freeform surfaces F₁ and F₂ may be represented by a polynomial basis, by splines, by finite elements, or by any other method known in the art, with the coefficients as parameters. The parameters of these components are determined via an optimization process that is explained in more detail below. The adjective “freeform” indicates that the surfaces F₁ and F₂ are not subject to any symmetry constraints.

At 908, the function E is iteratively optimized over the multiple gaze directions. Through that iterative optimization process, optimal parameters for a front surface u₁ of the front lens L₁ and for a back surface u₂ of the back lens L₂ are determined, thereby determining optimal front surface u₁ and optimal back surface u₂. (The other surfaces of the front lens L₁ and the back lens L₂ may be planar surfaces p₁ and p₂ that are substantially in contact with each other.) The optimal parameters may include, for example, optimal values for the radius of curvature c₁ and c₂ and the asphericity K₁ and K₂ of the base surfaces u_{b,1} and u_{b,2}, the Alvarez coefficients A₁ and A₂, and the parameters of the freeform surfaces F₁ and F₂. The iterative optimization process may involve conjugate gradients, or steepest descent, or Newton, or any other suitable method known in the art. The iterative optimization process is considered to have converged to an optimal solution (possibly one of many optimal solutions) once the change in the set of parameters at two successive iterations falls below a predetermined threshold.

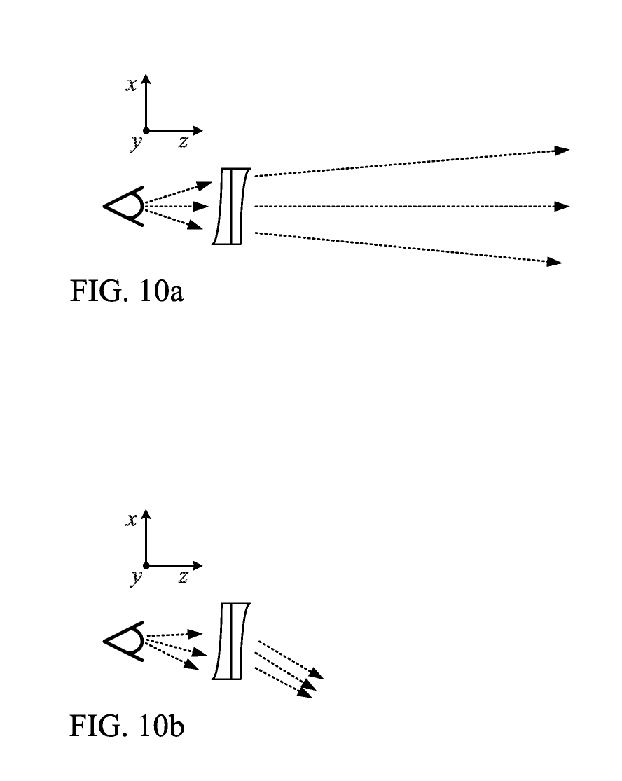

The function E is a sum over multiple gaze directions of weighted terms involving the optical power and the cylinder, at the first relative position and at the second relative position. At each iteration, the actual optical power and the actual cylinder for each of the multiple gaze directions is evaluated, taking into account the location of the object for each specific gaze direction. For example, multiple gaze directions are illustrated for far-distance objects in FIG. 10a and for near-distance objects in FIG. 10b. The actual optical power and the actual cylinder for each of the multiple gaze directions will depend on that iteration's version of the front surface u₁ and of the back surface u₂.

Returning now to FIG. 9, once the optimal front surface u₁ and the optimal back surface u₂ have been determined, an assessment is made to check whether the optical element O having the optimal surfaces u₁ and u₂ indeed provides in a first configuration good optical performance suitable for far-distance vision and in a second configuration good optical performance suitable for near-distance vision.

Good optical performance suitable for far-distance vision means that while the optical element O is in the first configuration (that is, the lenses are in the first relative position), the actual optical power within a first optical window of acceptable size surrounding the first point does not deviate noticeably from the predetermined optical power S (for example, does not deviate from S by more than 0.25 diopters) and the actual cylinder C₁ and actual cylinder direction α₁ within the first optical window does not deviate noticeably from the predetermined cylinder C (which may be zero diopters) in the cylinder direction α (for example, the deviation Cₑ is no more than 0.25 diopters).

Good optical performance suitable for near-distance vision means that while the optical element O is in the second configuration (that is, the lenses are in the second relative position), the actual optical power within a second optical window of acceptable size surrounding the second point does not deviate noticeably from the sum of the predetermined optical power S and the predetermined addition A (for example, does not deviate from (S+A) by more than 0.25 diopters) and the actual cylinder within the second optical window does not deviate noticeably from the predetermined cylinder C (which may be zero diopters) in the cylinder direction α (for example, the deviation Cₑ is no more than 0.50 diopters).

At 910, while the optical element O is in the first configuration, the size of a first optical window surrounding the first point within which the actual optical power and the actual cylinder do not deviate noticeably from the predetermined power S and from the predetermined cylinder C, respectively, is determined, and while the optical element O is in the second configuration, the size of a second optical window surrounding the second point within which the actual optical power and the actual cylinder do not deviate noticeably from the sum of the predetermined power S and the predetermined addition A and from the predetermined cylinder C, respectively, is determined.

At 912, it is checked whether the size of the first optical window is acceptable and whether the size of the second optical window is acceptable. If the optical windows are too small (compared to thresholds), then the result of the optimization is unsatisfactory. When the optical windows are represented as ellipses having axes along the horizontal and vertical directions, the threshold may be 35 degrees by 35 degrees of eye rotation, or 40 degrees by 40 degrees of eye rotation, or 45 degrees by 45 degrees of eye rotation, or 50 degrees by 50 degrees of eye rotation.

If the optical windows are too small, various factors may be modified, and the iterative optimization process is applied again to function E to determine updated optimal parameters for the front surface u₁ and for the back surface u₂. As illustrated by an arrow 914, different components for the front surface and/or for the back surface can be selected. Alternatively or additionally, the framework for the design method could be altered, as illustrated by an arrow 916. For example, weight distributions used in the function E could be altered, or different relative positions of the lenses could be chosen, or any combination of these changes.

If the optical windows are of acceptable size, then the result of the optimization is satisfactory, and, at 918, the optical element O having the optimal surfaces u₁ and u₂ indeed provides in a first configuration good optical performance suitable for far-distance vision and in a second configuration good optical performance suitable for near-distance vision.

In practice, the surfaces are represented as discrete points, and the integrals in the function E are replaced by sums. The calculations cannot be performed analytically, and computers are used to perform the calculations and to implement the iterative optimization method. In other words, computer programs are devised to carry out the optimization and assessment, and to output the numerical representation of the optimal surfaces u₁ and u₂.

Design for Far-Distance and Near-Distance, with Zero Cylinder

In this example, where the predetermined cylinder C is zero diopters, the function E may be formulated as follows:

E=∫w₁(x,y)(S₁(x,y)−S)²+v₁(x,y)(C₁(x,y))²+∫w₂(x,y)(S₂(x,y)−(S+A))²+v₂(x,y)(C₂(x,y))² (9)

where S₁(x,y) and C₁(x,y) are the actual optical power and the actual cylinder, respectively, of the optical element O while the lenses are in the first relative position when the eye gazes in a direction that intersects the back designed surface u₂ via the point (x,y,u₂(x,y)), and S₂(x,y) and C₂(x,y) are the actual optical power and the actual cylinder, respectively, of the optical element O while the lenses are in the second relative position when the eye gazes in a direction that intersects the back designed surface u₂ via the point (x,y,u₂(x,y)).

As described above, the values of the weight distributions w₁(x,y), (x,y), w₂(x,y), and v₂(x,y) may be changed to improve the results of the design.

Computing the actual optical power S₁(x,y) and the actual cylinder C₁(x,y) for a given gaze direction takes into account the locations of the far-distance objects. Computing the actual optical power S₂(x,y) and the actual cylinder C₂(x,y) for a given gaze direction takes into account the locations of the near-distance objects. Such computations are made to calculate the function E during the iterative optimization process (at 908) and also to calculate the size of the optical windows within which the power and the cylinder do not deviate noticeably (at 910).

The actual optical power and the actual cylinder for any gaze direction may be computed by any number of techniques. For example, the technique of computing the optical path length (OPL) between a point source and the intersection of rays emanating from this point and a plane located between the lens and the eye is described in B. Bourdoncle, J. O. Chauveau and J. L. Mercier, “Traps in displaying optical performances of a progressive addition lens”, Appl. Opt. vol. 31, 3586-3593, published 1992. Alternatively, the technique of propagating localized quadratic wavefronts is described in Kneisly, J. A. “Local curvature of wavefronts in optical system”, Journal of the Optical Society of America, vol. 44(2): 229-235 published in 1964. Other examples of techniques for calculating the actual optical power and the actual cylinder for any gaze direction are disclosed in U.S. Pat. No. 6,655,803 entitled “Wavefront method for designing optical elements” and in U.S. Pat. No. 6,824,268 entitled “Method for designing optical elements”.

Design for Far-Distance and Near-Distance, with Non-Zero Cylinder

In this example, where the predetermined cylinder C is non-zero, the function E may be formulated using the notion of cross cylinders as described above. Thus the function E may be formulated as follows:

E=∫w₁(x,y)(S₁(x,y)−S)²+v₁(x,y)(Cₑ(x,y))²+∫w₂(x,y)(S₂(x,y)−(S+A))²+v₂(x,y)(Cₑ(x,y))² (10)

where S₁(x,y) and Cₑ(x,y) are the actual optical power and the error in the actual cylinder, respectively, of the optical element O while the lenses are in the first relative position when the eye gazes in a direction that intersects the back designed surface u₂ via the point (x,y,u₂(x,y)), and S₂(x,y) and Cₑ(x,y) are the actual optical power and the error in the actual cylinder, respectively, of the optical element O while the lenses are in the second relative position when the eye gazes in a direction that intersects the back designed surface u₂ via the point (x,y,u₂(x,y)).

As described above, the values of the weight distributions w₁(x,y), v₁(x,y), w₂(x,y), and v₂(x,y) may be changed to improve the results of the design.

Computing the actual optical power S₁(x,y) and the actual cross cylinders, or alternatively computing the actual dioptric matrix T₁(x,y), for a given gaze direction takes into account the locations of the far-distance objects. Computing the actual optical power S₂(x,y) and the actual cross cylinders, or alternatively computing the actual dioptric matrix T₁(x,y), for a given gaze direction takes into account the locations of the near-distance objects. Such computations are made to calculate the function E during the iterative optimization process (at 908) and also to calculate the size of the optical windows within which the power and the cylinder do not deviate noticeably (at 910).

The actual optical power and the actual cross cylinders, or alternatively the actual dioptric matrix T₁(x,y), for any gaze direction may be computed by any number of techniques. For example, the technique of computing the optical path length (OPL) between a point source and the intersection of rays emanating from this point and a plane located between the lens and the eye is described in B. Bourdoncle, J. O. Chauveau and J. L. Mercier, “Traps in displaying optical performances of a progressive addition lens”, Appl. Opt. vol. 31, 3586-3593, published 1992. Alternatively, the technique of propagating localized quadratic wavefronts is described in Kneisly, J. A. “Local curvature of wavefronts in optical system”, Journal of the Optical Society of America, vol. 44(2): 229-235 published in 1964. Other examples of techniques for calculating the actual optical power and the actual cylinder for any gaze direction are disclosed in U.S. Pat. No. 6,655,803 entitled “Wavefront method for designing optical elements” and in U.S. Pat. No. 6,824,268 entitled “Method for designing optical elements”. When the eye views an object at an arbitrary direction it rotates in a way described by Listing's law. The computation of the optical power and the cross cylinders can be adjusted to this law by a number of techniques. For example, the technique described in S. Barbero and J. Rubinstein, “Power Adjustable Sphero-Cylindrical Refractor Comprising Two Lenses”, Optical Engineering vol. 52, 063002 published in 2013 can be used.

An alternative way to define the function E for the case of prescription with non-zero cylinder is to make use of a one-surface eye model having the predetermined optical power S and the predetermined cylinder C in the cylinder direction α. One example way to define the reduced-eye model is presented in J. Nam, J. Rubinstein and L. Thibos, “Wavelength adjustment using an eye model from aberrometry data”, J. Opt. Soc. Amer., 27, 1561-1574, published 2010. Once a reduced-eye model is defined, the function E specified in Equation (9) may be optimized, except that the calculations of the actual optical power S₁(x,y) and the actual cylinder C₁(x,y) for a given gaze direction of the lens-plus-eye system are performed immediately after light has passed through the one-surface eye model, and not immediately after light has passed through the optical element.

Design Method: Intermediate-Distance and Near-Distance

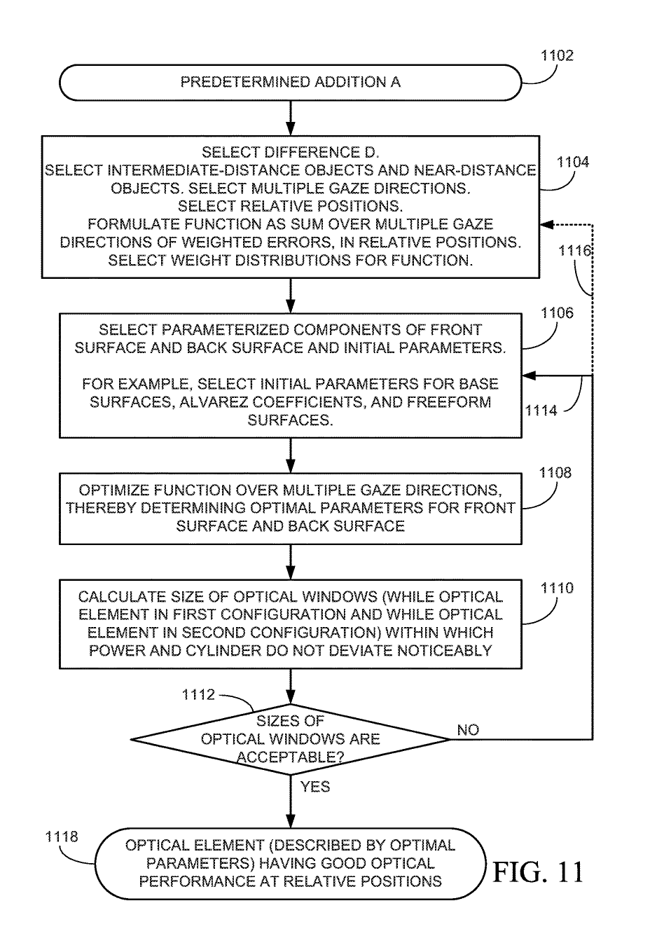

FIG. 11 is a simplified flowchart illustration of an example design method for designing the optical element O to provide good optical performance for intermediate-distance viewing and for near-distance viewing, as in the third case described above. In the third case described above, the object of the design method is to design an optical element O that in a first configuration provides good optical performance suitable for intermediate-distance vision and in a second configuration provides good optical performance suitable for near-distance vision. The good optical performance suitable for near-distance vision is expected to occur around a second point that is substantially aligned with a gaze direction that reflects the natural convergence of the eye when viewing a near-by object. Thus the second point is nearer to a nasal region of a person wearing adjustable glasses using the optical element O. The good optical performance suitable for intermediate-distance vision is expected to occur around a third point that is substantially aligned with a gaze direction that reflects the natural convergence of the eye when viewing objects located at an intermediate distance from the eye (for example, objects located approximately 70 to 100 centimeters from the eye).

At 1102, the design method receives as input a predetermined addition A. The predetermined addition A is in the range of +0.50 diopters to +3.00 diopters, and is likely one of the following {+0.50 diopters, +1.00 diopters, +1.50 diopters, +2.00 diopters, +2.50 diopters, +3.00 diopters} or one of the following {+0.50 diopters, +0.75 diopters, +1.00 diopters, +1.25 diopters, +1.50 diopters, +1.75 diopters, +2.00 diopters, +2.25 diopters, +2.50 diopters, +2.75 diopters, +3.00 diopters}.

The design method involves the optimization of a function E, where the function E is a sum over multiple gaze directions of weighted terms involving the optical power and the cylinder, while the optical element O is in the first configuration (that is, the lenses are in the first relative position) and while the optical element O is in the second configuration (that is, the lenses are in the second relative position).

At 1104, a framework for the design method is created. A coordinate system is defined, for example, an x-y-z coordinate system surrounding the eye. The difference D is selected. A person who requires an addition A to view near-distance objects likely requires an optical power of (A−D) to view intermediate-distance objects (where the difference D is in the range of 0.50 diopters to 1.75 diopters, for example, 1.00 diopters) because some accommodation is needed, although not as much accommodation as for viewing near-distance objects. Intermediate-distance objects (to be viewed when the optical element O is in the first configuration) and near-distance objects (to be viewed when the optical element O is in the second configuration) are selected. The intermediate-distance objects may be located approximately 70 to 100 centimeters from the eye. The near-distance objects may be located approximately 40 to 50 centimeters from the eye. Multiple gaze directions are selected. These gaze directions can be expressed angularly along the x- and y-directions, with a forward gaze direction having projection angles of zero degrees in both the x- and y-directions. The relative positions of the lenses that define the first configuration and the second configuration are selected. The function E is formulated, and weight distributions are selected. An example of the function E is described below.

At 1106, parameterized components for the front surface u₁ and for the back surface u₂, and initial parameters for the components are selected. For example, the front surface u₁ of the front lens L₁ may be formulated as described above in Equation (5) and Equation (6) with respect to FIG. 9.

The base surfaces u_{b,1} and u_{b,2} provide the optical power of the optical element O when in the rest position in the absence of the other terms in equations (5) and (6), which may be the optical power (A−D). They may be standard aspherical surfaces known in the art, or similar surfaces designed specifically for the present optical element by methods known in the art. For example, each base surface can take the form described above in Equation (7) and Equation (8) with respect to FIG. 9.

The base Alvarez surfaces having the Alvarez coefficients A₁ and A₂ and the freeform surfaces F₁ and F₂ are as described above with respect to FIG. 9.

At 1108, the function E is iteratively optimized over the multiple gaze directions, as described above for 908 with respect to FIG. 9. Through that iterative optimization process, optimal parameters for a front surface u₁ of the front lens L₁ and for a back surface u₂ of the back lens L₂ are determined, thereby determining optimal front surface u₁ and optimal back surface U₂.

Once the optimal front surface u₁ and the optimal back surface u₂ have been determined, an assessment is made to check whether the optical element O having the optimal surfaces u₁ and u₂ indeed provides in a first configuration good optical performance suitable for intermediate-distance vision and in a second configuration good optical performance suitable for near-distance vision.

Good optical performance suitable for intermediate-distance vision means that while the optical element O is in the first configuration (that is, the lenses are in the first relative position), the actual optical power within a third optical window of acceptable size surrounding the third point does not deviate noticeably from (A−D) (for example, does not deviate from (A−D) by more than 0.25 diopters) and the actual cylinder within the third optical window does not deviate noticeably from zero cylinder (for example, does not deviate from zero by more than 0.25 diopters).

Good optical performance suitable for near-distance vision means that while the optical element O is in the second configuration (that is, the lenses are in the second relative position), the actual optical power within a second optical window of acceptable size surrounding the second point does not deviate noticeably from the predetermined addition A (for example, does not deviate from A by more than 0.25 diopters) and the actual cylinder within the second optical window does not deviate noticeably from zero cylinder (for example, does not deviate from zero by more than 0.50 diopters).

At 1110, while the optical element O is in the first configuration, the size of a third optical window surrounding the third point within which the actual optical power and the actual cylinder do not deviate noticeably from (A−D) and from zero cylinder, respectively, is determined, and while the optical element O is in the second configuration, the size of a second optical window surrounding the second point within which the actual optical power and the actual cylinder do not deviate noticeably from the predetermined addition A and from zero cylinder, respectively, is determined.

At 1112, it is checked whether the size of the third optical window is acceptable and whether the size of the second optical window is acceptable. If the optical windows are too small (compared to thresholds), then the result of the optimization is unsatisfactory. When the optical windows are represented as ellipses having major and minor axes along the horizontal and vertical directions, the threshold may be 35 degrees by 35 degrees of eye rotation, or 40 degrees by 40 degrees of eye rotation, or 45 degrees by 45 degrees of eye rotation, or 50 degrees by 50 degrees of eye rotation.

If the optical windows are too small, various factors may be modified, and the iterative optimization process is applied again to function E to determine updated optimal parameters for the front surface u₁ and for the back surface u₂. As illustrated by an arrow 1114, different components for the front surface and/or for the back surface can be selected. Alternatively or additionally, the framework for the design method could be altered, as illustrated by an arrow 1116. For example, weight distributions used in the function E could be altered, or different relative positions of the lenses could be chosen, or any combination of these changes.

If the optical windows are of acceptable size, then the result of the optimization is satisfactory, and, at 1118, the optical element O having the optimal surfaces u₁ and u₂ indeed provides in a first configuration good optical performance suitable for intermediate-distance vision and in a second configuration good optical performance suitable for near-distance vision.

In practice, the surfaces are represented as discrete points, and the integrals in the function E are replaced by sums. The calculations cannot be performed analytically, and computers are used to perform the calculations and to implement the iterative optimization method. In other words, computer programs are devised to carry out the optimization and assessment, and to output the numerical representation of the optimal surfaces u₁ and u₂.

Design for Intermediate-Distance and Near-Distance, with Zero Cylinder

In this example, the function E may be formulated as follows:

E=∫(x,y)(S₁(x,y)−(A−D))²+v₁(x,y)(C₁(x,y))²+∫w₂(x,y)(S₂(x,y)−A)²+v₂(x,y)(C₂(x,y))² (11)

where S₁(x,y) and C₁(x,y) are the actual optical power and the actual cylinder, respectively, of the optical element O while the lenses are in the first relative position when the eye gazes in a direction that intersects the back designed surface u₂ via the point (x,y,u₂(x,y)), and S₂(x,y) and C₂(x,y) are the actual optical power and the actual cylinder, respectively, of the optical element O while the lenses are in the second relative position when the eye gazes in a direction that intersects the back designed surface u₂ via the point (x,y,u₂(x,y)).

As described above, the values of the weight distributions w₁(x,y), v₁(x,y), w₂(x,y), and v₂(x,y) may be changed to improve the results of the design.

Computing the actual optical power S₁(x,y) and the actual cylinder C₁(x,y) for a given gaze direction takes into account the locations of the intermediate-distance objects. Computing the actual optical power S₂(x,y) and the actual cylinder C₂(x,y) for a given gaze direction takes into account the locations of the near-distance objects. Such computations are made to calculate the function E during the iterative optimization process (at 1108) and also to calculate the size of the optical windows within which the power and the cylinder do not deviate noticeably (at 1110).

The actual optical power and the actual cylinder for any gaze direction may be computed by any number of techniques. For example, the technique of computing the optical path length (OPL) between a point source and the intersection of rays emanating from this point and a plane located between the lens and the eye is described in B. Bourdoncle, J. O. Chauveau and J. L. Mercier, “Traps in displaying optical performances of a progressive addition lens”, Appl. Opt. vol. 31, 3586-3593, published 1992. Alternatively, the technique of propagating localized quadratic wavefronts is described in Kneisly, J. A. “Local curvature of wavefronts in optical system”, Journal of the Optical Society of America, vol. 44(2): 229-235 published in 1964. Other examples of techniques for calculating the actual optical power and the actual cylinder for any gaze direction are disclosed in U.S. Pat. No. 6,655,803 entitled “Wavefront method for designing optical elements” and in U.S. Pat. No. 6,824,268 entitled “Method for designing optical elements”.

Design Method for Three Optical Powers

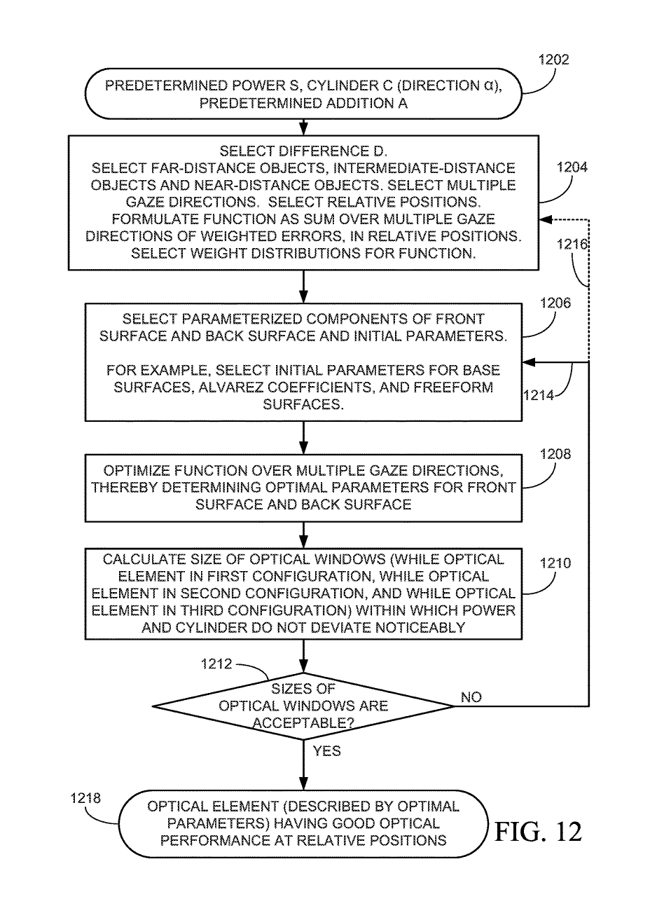

In the variant of the first case described above and in the variant of the second case described above, the object of the design method is to design an optical element O that in a first configuration provides good optical performance suitable for far-distance vision, in a second configuration provides good optical performance suitable for near-distance vision, and in a third configuration provides good optical performance suitable for intermediate-distance vision. FIG. 12 is a simplified flowchart illustration of an example design method for designing the optical element O. The good optical performance suitable for far-distance vision is expected to occur around a first point that is substantially aligned with a forward gaze direction, and the good optical performance suitable for near-distance vision is expected to occur around a second point that is substantially aligned with a gaze direction that reflects the natural convergence of the eye when viewing a near-by object. Thus the second point is nearer to a nasal region of a person wearing adjustable glasses using the optical element O. The good optical performance suitable for intermediate-distance vision is expected to occur around a third point that is substantially aligned with a gaze direction that reflects the natural convergence of the eye when viewing objects located at an intermediate distance from the eye (for example, objects located approximately 70 to 100 centimeters from the eye).

At 1202, the design method receives as input a predetermined optical power S, a predetermined addition A, a predetermined cylinder C (which may be zero or non-zero), and, in the case that the predetermined cylinder C is non-zero, a predetermined cylinder direction α. The predetermined addition A is in the range of +0.50 diopters to +3.00 diopters, and is likely one of the following {+0.50 diopters, +1.00 diopters, +1.50 diopters, +2.00 diopters, +2.50 diopters, +3.00 diopters} or one of the following {+0.50 diopters, +0.75 diopters, +1.00 diopters, +1.25 diopters, +1.50 diopters, +1.75 diopters, +2.00 diopters, +2.25 diopters, +2.50 diopters, +2.75 diopters, +3.00 diopters}.

The design method involves the optimization of a function E, where the function E is a sum over multiple gaze directions of weighted terms involving the optical power and the cylinder, while the optical element O is in the first configuration (that is, the lenses are in the first relative position) and while the optical element O is in the second configuration (that is, the lenses are in the second relative position) and while the optical element O is in the third configuration (that is, the lenses are in the third relative position).

At 1204, a framework for the design method is created. A coordinate system is defined, for example, an x-y-z coordinate system surrounding the eye. A difference D is selected. A person who has a prescription of far-distance power correction given by a predetermined optical power S and a predetermined addition A (where A is in the range of +0.50 diopters to +3.00 diopters) likely requires an optical power of (S+A−D) to view intermediate-distance objects (where the difference D is in the range of 0.50 diopters to 1.75 diopters, for example, 1.00 diopters) because some accommodation is needed, although not as much accommodation as for viewing near-distance objects. Far-distance objects (to be viewed when the optical element O is in the first configuration), intermediate-distance objects (to be viewed when the optical element O is in the third configuration), and near-distance objects (to be viewed when the optical element O is in the second configuration) are selected. The far-distance objects may be located approximately 10 meters from the eye. The intermediate-distance objects may be located approximately 70 to 100 centimeters from the eye. The near-distance objects may be located approximately 40 to 50 centimeters from the eye. Multiple gaze directions are selected. These gaze directions can be expressed angularly along the x- and y-directions, with a forward gaze direction having projection angles of zero degrees in both the x- and y-directions. The relative positions of the lenses that define the first configuration and the second configuration are selected. The function E is formulated, and weight distributions are selected. Examples of the function E are described below.

At 1206, parameterized components for the front surface u₁ and for the back surface u₂, and initial parameters for the components are selected. For example, the front surface u₁ of the front lens L₁ may be formulated as described above in Equation (5) and Equation (6) with respect to FIG. 9.

The base surfaces u_{b,1} and U_{b,2} provide the optical power of the optical element O when in the rest position in the absence of the other terms in equations (5) and (6), which may be the optical power (S+A−D). They may be standard aspherical surfaces known in the art, or similar surfaces designed specifically for the present optical element by methods known in the art. For example, each base surface can take the form described above in Equation (7) and Equation (8) with respect to FIG. 9.

The base Alvarez surfaces having the Alvarez coefficients A₁ and A₂ and the freeform surfaces F₁ and F₂ are as described above with respect to FIG. 9.

At 1208, the function E is iteratively optimized over the multiple gaze directions, as described above for 908 with respect to FIG. 9. Through that iterative optimization process, optimal parameters for a front surface u₁ of the front lens L₁ and for a back surface u₂ of the back lens L₂ are determined, thereby determining optimal front surface u₁ and optimal back surface U₂.

Once the optimal front surface u₁ and the optimal back surface u₂ have been determined, an assessment is made to check whether the optical element O having the optimal surfaces u₁ and u₂ indeed provides in a first configuration good optical performance suitable for far-distance vision, in a second configuration good optical performance suitable for near-distance vision, and in a third configuration good optical performance suitable for intermediate-distance vision.

Good optical performance suitable for far-distance vision means that while the optical element O is in the first configuration (that is, the lenses are in the first relative position), the actual optical power within a first optical window of acceptable size surrounding the first point does not deviate noticeably from the predetermined power S (for example, does not deviate from S by more than 0.25 diopters) and the actual cylinder within the first optical window does not deviate noticeably from the predetermined cylinder C (which may be zero diopters) in the cylinder direction α (for example, the deviation Cₑ is no more than 0.25 diopters).

Good optical performance suitable for near-distance vision means that while the optical element O is in the second configuration (that is, the lenses are in the second relative position), the actual optical power within a second optical window of acceptable size surrounding the second point does not deviate noticeably from the sum of the predetermined optical power S and the predetermined addition A (for example, does not deviate from (S+A) by more than 0.25 diopters) and the actual cylinder within the second optical window does not deviate noticeably from the predetermined cylinder (for example, the deviation Cₑ is no more than 0.50 diopters).

Good optical performance suitable for intermediate-distance vision means that while the optical element O is in the third configuration (that is, the lenses are in the third relative position), the actual optical power within a third optical window of acceptable size surrounding the third point does not deviate noticeably from (S+A−D) (for example, does not deviate from (S+A−D) by more than 0.25 diopters) and the actual cylinder within the third optical window does not deviate noticeably from the predetermined cylinder (for example, the deviation Cₑ is no more than 0.25 diopters).

At 1210, while the optical element O is in the first configuration, the size of a first optical window surrounding the first point within which the actual optical power does not deviate noticeably from the predetermined power S and the actual cylinder does not deviate noticeably from the predetermined cylinder, respectively, is determined. At 1210, while the optical element O is in the second configuration, the size of a second optical window surrounding the second point within which the actual optical power does not deviate noticeably from (S+A) and the actual cylinder does not deviate noticeably from the predetermined cylinder is determined. At 1210, while the optical element O is in the third configuration, the size of a third optical window surrounding the third point within which the actual optical power does not deviate noticeably from (S+A−D) and the actual cylinder does not deviate noticeably from the predetermined cylinder is determined.

At 1212, it is checked whether the size of the third optical window is acceptable and whether the size of the second optical window is acceptable. If the optical windows are too small (compared to thresholds), then the result of the optimization is unsatisfactory. When the optical windows are represented as ellipses having major and minor axes along the horizontal and vertical directions, the threshold may be 35 degrees by 35 degrees of eye rotation, or 40 degrees by 40 degrees of eye rotation, or 45 degrees by 45 degrees of eye rotation, or 50 degrees by 50 degrees of eye rotation.

If the optical windows are too small, various factors may be modified, and the iterative optimization process is applied again to function E to determine updated optimal parameters for the front surface u₁ and for the back surface u₂. As illustrated by an arrow 1214, different components for the front surface and/or for the back surface can be selected. Alternatively or additionally, the framework for the design method could be altered, as illustrated by an arrow 1216. For example, weight distributions used in the function E could be altered, or different relative positions of the lenses could be chosen, or any combination of these changes.

If the optical windows are of acceptable size, then the result of the optimization is satisfactory, and, at 1218, the optical element O having the optimal surfaces u₁ and u₂ indeed provides in a first configuration good optical performance suitable for far-distance vision and in a second configuration good optical performance suitable for near-distance vision and in a third configuration good optical performance suitable for intermediate-distance vision.

Design for Far-Distance, Intermediate-Distance and Near-Distance, with Zero Cylinder

In this example, the function E may be formulated as follows:

$$E = \int {w}_{1} ( x , y ) {( {S}_{1} ( x , y ) - S )}^{2} + {v}_{1} ( x , y ) {( {C}_{1} ( x , y ) )}^{2} + \int {w}_{2} ( x , y ) {( {S}_{2} ( x , y ) - ( S + A ) )}^{2} + {v}_{2} ( x , y ) {( {C}_{2} ( x , y ) )}^{2} + \int {w}_{3} ( x , y ) {( {S}_{3} ( x , y ) - ( S + A - D ) )}^{2} + {v}_{3} ( x , y ) {( {C}_{3} ( x , y ) )}^{2} \qquad ( 12 )$$

where S₁(x,y) and C₁(x,y) are the actual optical power and the actual cylinder, respectively, of the optical element O while the lenses are in the first relative position when the eye gazes in a direction that intersects the back designed surface u₂ via the point (x,y,u₂(x,y)), and S₂(x,y) and C₂(x,y) are the actual optical power and the actual cylinder, respectively, of the optical element O while the lenses are in the second relative position when the eye gazes in a direction that intersects the back designed surface u₂ via the point (x,y,u₂(x,y)), and S₃(x,y) and C₃(x,y) are the actual optical power and the actual cylinder, respectively, of the optical element O while the lenses are in the third relative position when the eye gazes in a direction that intersects the back designed surface u₂ via the point (x,y,u₂(x,y)).

As described above, the values of the weight distributions w₁(x,y), v₁(x,y), w₂(x,y), v₂(x,y), w₃(x,y), and v₃(x,y) may be changed to improve the results of the design.

Design for Far-Distance, Intermediate-Distance and Near-Distance, with Non-Zero Cylinder

In this example, the function E may be formulated as follows:

$$E = \int {w}_{1} ( x , y ) {( {S}_{1} ( x , y ) - S )}^{2} + {v}_{1} ( x , y ) {( {C}_{e} ( x , y ) )}^{2} + \int {w}_{2} ( x , y ) {( {S}_{2} ( x , y ) - ( S + A ) )}^{2} + {v}_{2} ( x , y ) {( {C}_{e} ( x , y ) )}^{2} + \int {w}_{3} ( x , y ) {( {S}_{3} ( x , y ) - ( S + A - D ) )}^{2} + {v}_{3} ( x , y ) {( {C}_{e} ( x , y ) )}^{2} \qquad ( 13 )$$

where S₁(x,y) and Cₑ(x,y) are the actual optical power and the error in the actual cylinder, respectively, of the optical element O while the lenses are in the first relative position when the eye gazes in a direction that intersects the back designed surface u₂ via the point (x,y,u₂(x,y)), and S₂(x,y) and Cₑ(x,y) are the actual optical power and the error in the actual cylinder, respectively, of the optical element O while the lenses are in the second relative position when the eye gazes in a direction that intersects the back designed surface u₂ via the point (x,y,u₂(x,y)), and S₃(x,y) and Cₑ(x,y) are the actual optical power and the error in the actual cylinder, respectively, of the optical element O while the lenses are in the third relative position when the eye gazes in a direction that intersects the back designed surface u₂ via the point (x,y,u₂(x,y)).

As described above, the values of the weight distributions w₁(x,y), v₁(x,y), w₂(x,y), v₂(x,y), w₃(x,y), and v₃(x,y) may be changed to improve the results of the design.

Results

### Example 1: Addition of +2.0 Diopters

In this example design, the central thickness of the front lens is 1.4 mm (millimeters) and the central thickness of the back lens is 2.4 mm. The refractive index of the front lens and the back lens is n=1.586. While the planar surfaces of the front lens and the back lens are coincident (a “rest position”), the optical power at a point substantially aligned with a forward gaze direction is −2.3 diopters. While the lenses are in a first relative position, achieved by a horizontal shift of 2 mm of the front lens in the negative x-direction from the rest position, the optical power at a first point substantially aligned with a forward gaze direction is −3 diopters. While the lenses are in a second relative position, achieved by a horizontal shift of 4 mm of the front lens in the positive x-direction from the rest position, the optical power at a second point is −1 diopters. The second point is located nearer to the nasal region, and is located approximately at (5,0), where the coordinates refer to eye rotations.

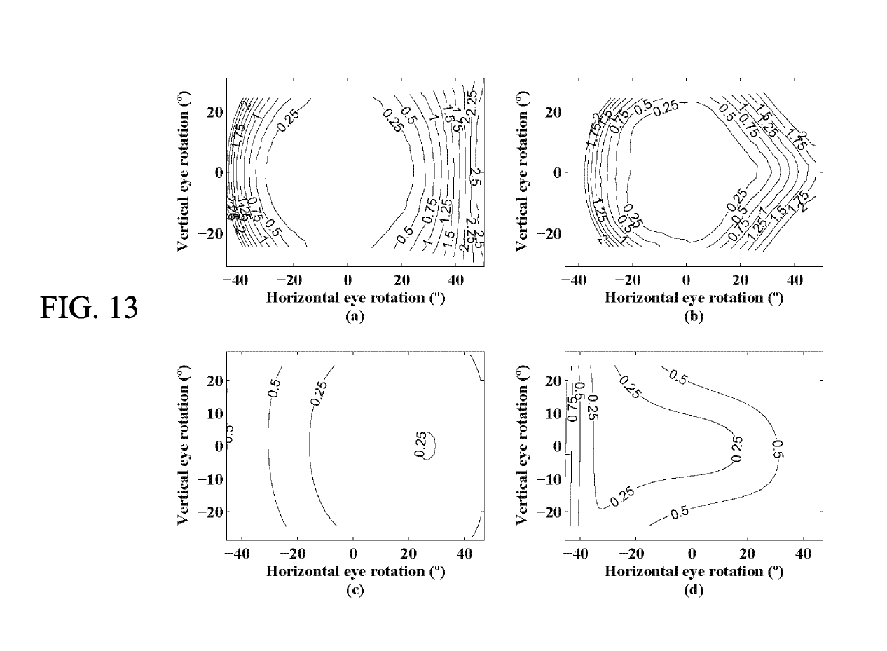

FIG. 13a shows the power error distribution (the deviation of optical power from the predetermined −3 diopters) for different gaze directions for the first relative position. The deviation is less than 0.25 diopters within an elliptical optical window having major and minor axes of at least 40 degrees by 40 degrees of eye rotation.

FIG. 13b shows the cylinder error distribution (the deviation of cylinder from the predetermined zero diopters) for different gaze directions for the first relative position. The deviation is less than 0.25 diopters within an elliptical optical window having major and minor axes of at least 40 degrees by 40 degrees of eye rotation.

FIG. 13c shows the power error distribution (the deviation of optical power from the predetermined −1 diopters) for different gaze directions for the second relative position. The deviation is less than 0.25 diopters within an elliptical optical window having major and minor axes of at least 40 degrees by 40 degrees of eye rotation.

FIG. 13d shows the cylinder error distribution (the deviation of cylinder from the predetermined zero diopters) for different gaze directions for the second relative position. The deviation is less than 0.25 diopters within an elliptical optical window having major and minor axes of at least 40 degrees by 40 degrees of eye rotation.

### Example 2: Addition of +3.0 Diopters

In this example design, the central thickness of the front lens is 2.25 mm (millimeters) and the central thickness of the back lens is 3 mm. The refractive index of the front lens and the back lens is n=1.586. While the planar surfaces of the front lens and the back lens are coincident (a “rest position”), the optical power at a point substantially aligned with a forward gaze direction is −1.7 diopters. While the lenses are in a first relative position, achieved by a horizontal shift of 3.5 mm of the front lens in the negative x-direction from the rest position, the optical power at a first point substantially aligned with a forward gaze direction is −3 diopters. While the lenses are in a second relative position, achieved by a horizontal shift of 4.5 mm of the front lens in the positive x-direction from the rest position, the optical power at a second point is zero diopters. The second point is located nearer to the nasal region, and is located approximately at (5,0), where the coordinates refer to eye rotations.

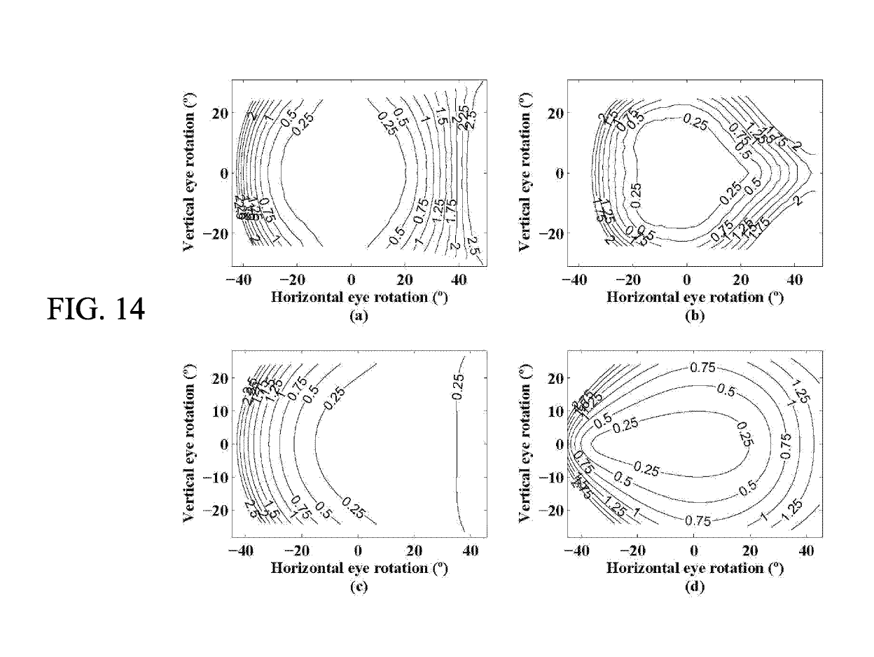

FIG. 14a shows the power error distribution (the deviation of optical power from the predetermined −3 diopters) for different gaze directions for the first relative position. The deviation is less than 0.25 diopters within an elliptical optical window having major and minor axes of at least 40 degrees by 40 degrees of eye rotation.

FIG. 14b shows the cylinder error distribution (the deviation of cylinder from the predetermined zero diopters) for different gaze directions for the first relative position. The deviation is less than 0.25 diopters within an elliptical optical window having major and minor axes of at least 40 degrees by 40 degrees of eye rotation.

FIG. 14c shows the power error distribution (the deviation of optical power from the predetermined zero diopters) for different gaze directions for the second relative position. The deviation is less than 0.25 diopters within an elliptical optical window having major and minor axes of at least 40 degrees by 40 degrees of eye rotation.

FIG. 14d shows the cylinder error distribution (the deviation of cylinder from the predetermined zero diopters) for different gaze directions for the second relative position. The deviation is less than 0.5 diopters within an elliptical optical window having major and minor axes of at least 40 degrees by 30 degrees of eye rotation.

### Example 3: Addition of +1.0 Diopters

In this example design, the central thickness of the front lens is 1.4 mm (millimeters) and the central thickness of the back lens is 2 mm. The refractive index of the front lens and the back lens is n=1.586. While the lenses are in a first relative position, achieved by a horizontal shift of 3 mm of the front lens in the negative x direction while the back lens remains fixed, the optical power at a point substantially aligned with the forward gaze is +1.5 diopters. While the planar surfaces of the front lens and the back lens are coincident (a “rest position”), which is the second relative position, the optical power at a second point is +2.5 diopters. A person with no far-distance vision prescription (emmetropic) who needs +2.5 diopters for reading can used this optical element both for reading tasks and also for intermediate distance tasks, such as viewing a computer screen.

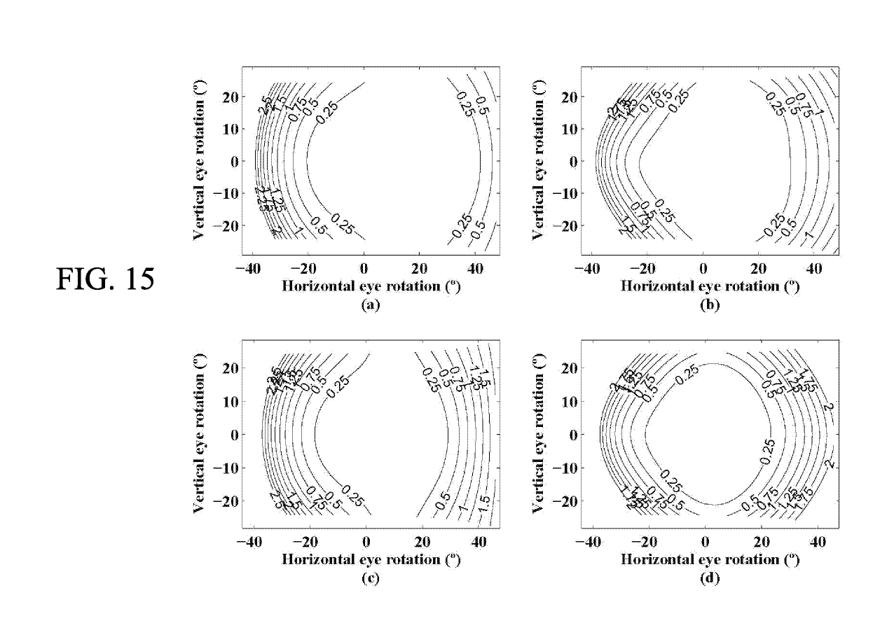

FIG. 15a shows the power error distribution (the deviation of optical power from the predetermined +1.5 diopters) for different gaze directions for the first relative position. The deviation is less than 0.25 diopters within an elliptical optical window having major and minor axes of at least 45 degrees by 45 degrees of eye rotation.

FIG. 15b shows the cylinder error distribution (the deviation of cylinder from the predetermined zero diopters) for different gaze directions for the first relative position. The deviation is less than 0.25 diopters within an elliptical optical window having major and minor axes of at least 45 degrees by 45 degrees of eye rotation.

FIG. 15c shows the power error distribution (the deviation of optical power from the predetermined +2.5 diopters) for different gaze directions for the second relative position. The deviation is less than 0.25 diopters within an elliptical optical window having major and minor axes of at least 45 degrees by 45 degrees of eye rotation.

FIG. 15d shows the cylinder error distribution (the deviation of cylinder from the predetermined zero diopters) for different gaze directions for the second relative position. The deviation is less than 0.25 diopters within an elliptical optical window having major and minor axes of at least 45 degrees by 45 degrees of eye rotation. The deviation is less than 0.5 diopters within an elliptical optical window having major and minor axes of at least 50 degrees by 50 degrees eye rotation.

What is claimed is:

1. An optical element for use in power adjustable spectacles, the optical element comprising:
a front lens and a back lens which can slide laterally with respect to each other to achieve a first relative position and a second relative position,
wherein while the lenses are in the first relative position, actual optical power within a first optical window of acceptable size surrounding a first point does not deviate noticeably from a predetermined optical power S and actual cylinder and actual cylinder direction within the first optical window do not deviate noticeably from a predetermined cylinder C in a predetermined cylinder direction α,
wherein while the lenses are in the second relative position, actual optical power within a second optical window of acceptable size surrounding a second point does not deviate noticeably from a sum of the predetermined optical power S and a predetermined addition A and actual cylinder and actual cylinder direction within the second optical window do not deviate noticeably from the predetermined cylinder C in the predetermined cylinder direction α, and
wherein the first point is substantially aligned with a forward gaze direction, the second point is to be located near a nasal region of a person who will wear the power adjustable spectacles, and the predetermined addition A is between 0.50 diopters and 3.00 diopters.

2. The optical element as recited in claim 1, wherein while the lenses are in a third relative position between the first relative position and the second relative position, actual optical power within a third optical window of acceptable size surrounding a third point does not deviate noticeably from the sum of the predetermined optical power S and the predetermined addition A minus a difference D, and actual cylinder and actual cylinder direction within the third optical window do not deviate noticeably from the predetermined cylinder C in the predetermined cylinder direction α,
wherein the third point is substantially aligned with a gaze direction that reflects natural convergence of an eye when viewing objects located at an intermediate distance from the eye, and
wherein the difference D is less than the predetermined addition A.

3. The optical element as recited in claim 1, wherein the predetermined addition A is between 0.50 diopters and 1.00 diopters, the first optical window of acceptable size is an ellipse surrounding the first point having major and minor axes of approximately 45 degrees or larger by 45 degrees or larger, and the second optical window of acceptable size is an ellipse surrounding the second point having major and minor axes of approximately 45 degrees or larger by 45 degrees or larger.

4. The optical element as recited in claim 1, wherein the predetermined addition A is between 1.25 diopters and 2.50 diopters, the first optical window of acceptable size is an ellipse surrounding the first point having major and minor axes of approximately 40 degrees or larger by 40 degrees or larger, and the second optical window of acceptable size is an ellipse surrounding the second point having major and minor axes of approximately 40 degrees or larger by 40 degrees or larger.

5. The optical element as recited in claim 1, wherein the predetermined addition A is between 2.75 diopters and 3.00 diopters, the first optical window of acceptable size is an ellipse surrounding the first point having major and minor axes of approximately 40 degrees or larger by 40 degrees or larger, and wherein the second optical window of acceptable size is an ellipse surrounding the second point having major and minor axes of approximately 40 degrees or larger by 30 degrees or larger.

6. The optical element as recited in claim 1, wherein one of the relative positions of the lenses is achieved when planar surfaces of the lenses are coincident.

7. The optical element as recited in claim 1, wherein one of the relative positions of the lenses is achieved by sliding one of the lenses laterally relative to a frame of the power adjustable spectacles while the other of the lenses remains fixed relative to the frame.

8. The optical element as recited in claim 1, wherein one of the relative positions of the lenses is achieved by sliding both of the lenses laterally in opposite directions relative to a frame of the power adjustable spectacles.

9. An optical element for use in power adjustable spectacles, the optical element comprising:
a front lens and a back lens which can slide laterally with respect to each other to achieve a first relative position and a second relative position,
wherein while the lenses are in the second relative position, actual optical power within a second optical window of acceptable size surrounding a second point does not deviate noticeably from a predetermined addition A, and the magnitude of actual cylinder within the second optical window does not deviate noticeably from zero diopters,
wherein while the lenses are in the first relative position, actual optical power within a third optical window of acceptable size surrounding a third point does not deviate noticeably from the predetermined addition A minus a difference D, and the magnitude of actual cylinder within the third optical window does not deviate noticeably from zero diopters, and
wherein the second point is to be located near a nasal region of a person who will wear the power adjustable spectacles, the third point is substantially aligned with a gaze direction that reflects natural convergence of an eye when viewing objects located at an intermediate distance from the eye, the predetermined addition A is between 0.50 diopters and 3.00 diopters, and the difference D is less than the predetermined addition A.

10. The optical element as recited in claim 9, wherein the predetermined addition A minus the difference D is between 1.25 diopters and 2.50 diopters, the third optical window of acceptable size is an ellipse surrounding the third point having major and minor axes of approximately 40 degrees or larger by 40 degrees or larger, and the second optical window of acceptable size is an ellipse surrounding the second point having major and minor axes of approximately 40 degrees or larger by 40 degrees or larger.

11. The optical element as recited in claim 9, wherein the predetermined addition A minus the difference D is between 0.25 diopters and 1.00 diopters, the third optical window of acceptable size is an ellipse surrounding the third point having major and minor axes of approximately 45 degrees or larger by 45 degrees or larger, and wherein the second optical window of acceptable size is an ellipse surrounding the second point having major and minor axes of approximately 45 degrees or larger by 45 degrees or larger.

12. The optical element as recited in claim 9, wherein one of the relative positions of the lenses is achieved when planar surfaces of the lenses are coincident.

13. The optical element as recited in claim 9, wherein one of the relative positions of the lenses is achieved by sliding one of the lenses laterally relative to a frame of the power adjustable spectacles while the other of the lenses remains fixed relative to the frame.

14. The optical element as recited in claim 9, wherein one of the relative positions of the lenses is achieved by sliding both of the lenses laterally in opposite directions relative to a frame of the power adjustable spectacles.

15. Power adjustable spectacles comprising a frame and an optical element as recited in claim 1.

16. Power adjustable spectacles comprising a frame and an optical element as recited in claim 9.

17. Power adjustable spectacles comprising a frame, a first optical element as recited in claim 9 for a left eye, and a second optical element as recited in claim 9 for a right eye.

18. A method for designing an optical element to be used in power adjustable spectacles, the method comprising:
representing the optical element as two lenses which can slide laterally with respect to each other to achieve a first relative position and a second relative position, each of the two lenses having a planar surface and a designed surface;
representing each designed surface as a combination of a base surface, an Alvarez surface, and a free-form surface;
formulating a function as a sum over multiple gaze directions of weighted errors in optical power and weighted errors in cylinder, in the first relative position and in the second relative position;
selecting initial parameters for each designed surface, including Alvarez coefficients and parameters of the free-form surfaces, and selecting initial values of weights for the cost function;
optimizing the cost function with respect to the parameters using an iterative process until the iterative process has converged, thereby determining optimal parameters;
evaluating power error and cylinder error distributions for the multiple gaze directions for the surfaces defined by the optimal parameters, in the first relative position and in the second relative position, thereby determining size of optical window for the first relative position and for the second relative position; and
selecting different initial parameters or different initial values of weights or different shifts, and repeating the optimizing of the cost function and the evaluating of the distributions, until the size of the optical window is acceptable.

19. The method as recited in claim 18, wherein in the first relative position, errors in optical power are deviations of optical power from a predetermined optical power S, and in the second relative position, errors in the optical power are deviations of optical power from a sum of the predetermined optical power S and a predetermined addition A, the predetermined addition A is between 0.50 diopters and 3.00 diopters.

20. The method as recited in claim 18, wherein in the first relative position, errors in optical power are deviations of optical power from a predetermined addition A, and in the second relative position, errors in the optical power are deviations of optical power from the predetermined addition A minus a difference D, wherein the predetermined addition A is between 0.50 diopters and 3.00 diopters, and the difference D is less than the predetermined addition A.

21. An optical element designed by the method as recited in claim 18.

22. Power adjustable spectacles comprising a frame and an optical element as recited in claim 21.
